(19) United States
(12) Patent Application Publication
(10) Pub. No.: US 2026/0211361 A1
(43) Pub. Date: Jul. 23, 2026

(54) REFLECTOR, HEATING DEVICE, FIXING DEVICE, AND IMAGE FORMING APPARATUS

(71) Applicant: Kentaro YAMANAKA, Kanagawa (JP)

(72) Inventor: Kentaro YAMANAKA, Kanagawa (JP)

(21) Appl. No.: 19/372,273

(22) Filed: Oct. 29, 2025

(30) Foreign Application Priority Data
Jan. 22, 2025 (JP) 2025-009240

(51) Int. Cl. G03G 15/20

(52) U.S. Cl. CPC G03G 15/2053; G03G 15/2064; G03G 15/2007; G03G 2215/2035

(57) ABSTRACT

A reflector includes a reflecting portion, a pressure receiving portion, and a connecting portion. The reflecting portion is in a rotator of a heating device and reflects heat from a heater in the rotator. The pressure receiving portion is in the rotator and receives pressure via the rotator from a pressure rotator of the heating device. The pressure rotator is outside the rotator. The pressure receiving portion is thermally connected to the reflecting portion. The connecting portion connects the reflecting portion and the pressure receiving portion. At least one of the pressure receiving portion or the connecting portion has a hole.

### CROSS-REFERENCE TO RELATED APPLICATION

This patent application is based on and claims priority pursuant to 35 U.S.C. § 119(a) to Japanese Patent Application No. 2025-009240, filed on Jan. 22, 2025, in the Japan Patent Office, the entire disclosure of which is hereby incorporated by reference herein.

### BACKGROUND

### Technical Field

The present disclosure relates to a reflector, a heating device, a fixing device, and an image forming apparatus.

### Related Art

One type of image forming apparatus includes a fixing device that is an example of a heating device. The fixing device includes an endless fixing belt that is an example of a rotator, a heater radiating radiant heat, and a reflector inside the loop of the fixing belt. The reflector reflects the radiant heat from the heater to the inner face of the fixing belt to heat the fixing belt effectively.

### SUMMARY

The present disclosure described herein provides a reflector including a reflecting portion, a pressure receiving portion, and a connecting portion. The reflecting portion is in a rotator of a heating device and reflects heat from a heater in the rotator. The pressure receiving portion is in the rotator and receives pressure via the rotator from a pressure rotator of the heating device. The pressure rotator is outside the rotator. The pressure receiving portion is thermally connected to the reflecting portion. The connecting portion connects the reflecting portion and the pressure receiving portion. At least one of the pressure receiving portion or the connecting portion has a hole.

The present disclosure described herein also provides a reflector including a reflecting portion, a pressure receiving portion, and a connecting portion. The reflecting portion is in a rotator of a heating device and reflects heat from a heater in the rotator. The pressure receiving portion is in the rotator and receives pressure via the rotator from a pressure rotator of the heating device. The pressure rotator is outside the rotator. The pressure receiving portion is thermally connected to the reflecting portion. The connecting portion connects the reflecting portion and the pressure receiving portion. At least one of the pressure receiving portion or the connecting portion has a groove.

The present disclosure described herein further provides a reflector including a reflecting portion, a pressure receiving portion, and a connecting portion. The reflecting portion is in a rotator of a heating device and reflects heat from a heater in the rotator. The pressure receiving portion is in the rotator and receives pressure via the rotator from a pressure rotator of the heating device. The pressure rotator is outside the rotator. The pressure receiving portion is thermally connected to the reflecting portion. The connecting portion connects the reflecting portion and the pressure receiving portion. At least one of the pressure receiving portion or the connecting portion includes a first portion having a first thermal conductivity, the reflector has a second portion, other than the first portion, and the second portion has a second thermal conductivity higher than the first thermal conductivity.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of an image forming apparatus;

FIG. 2 is a schematic diagram illustrating a configuration of a fixing device;

FIG. 3 is a partial perspective view of a reflector, a nip formation pad, and a stay that are assembled;

FIG. 4 is a schematic diagram illustrating another configuration of a fixing device;

FIG. 5 is a diagram illustrating heat transfer from a hot reflector to a fixing belt;

FIG. 6 is a diagram illustrating heat transfer from a fixing belt to a cold reflector;

FIG. 7 is a perspective view of a reflector;

FIG. 8 is a perspective view of a reflector according to a modification;

FIG. 9 is a perspective view of a reflector according to a modification;

FIG. 10 is a perspective view of a reflector according to a modification;

FIG. 11 is a perspective view of a reflector according to a modification;

FIG. 12 is a perspective view of a reflector according to a modification;

FIG. 13 is a plan view of a reflector according to a modification;

FIG. 14 is a schematic diagram illustrating another configuration of a fixing device;

FIG. 15A is a perspective view of a reflector according to a modification;

FIG. 15B is a cross-sectional view of a pressure receiving portion of the reflector of FIG. 15A taken along the line B1-B1 in FIG. 15A;

FIG. 16A is a perspective view of a reflector according to a modification; and

FIG. 16B is a cross-sectional view of a pressure receiving portion of the reflector of

FIG. 16A taken along the line B2-B2 in FIG. 16A.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Referring to the drawings, embodiments of the present disclosure are described below. Like reference signs are assigned to like elements or components and descriptions of those elements or components may be simplified or omitted. In the following description, a fixing device disposed in an image forming apparatus is described as an example of a heating device.

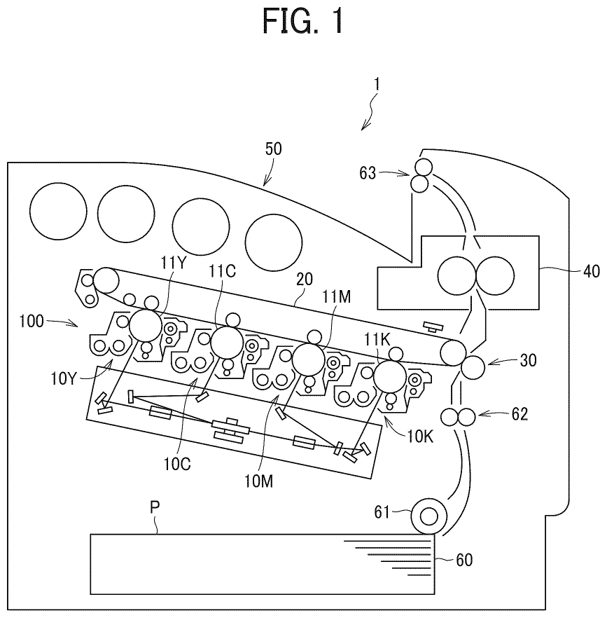

A laser printer employing an electrophotographic image forming system is described below as an example of the image forming apparatus. FIG. 1 is a diagram illustrating a schematic configuration of an image forming apparatus 1 according to the embodiment. The image forming apparatus 1 includes an image forming section 100 to form an image on a sheet P as a recording medium. The image forming apparatus 1 is a tandem-type image forming apparatus. The image forming section 100 includes image forming devices 10Y, 10M, 10C, and 10K for respective colors of yellow (Y), magenta (M), cyan (C), and black (K) and an intermediate transfer belt 20 as an intermediate transferor. The image forming devices 10Y, 10M, 10C, and 10K are arranged along a rotation direction of the intermediate transfer belt 20 on the intermediate transfer belt 20. The image forming devices 10Y, 10M, 10C, and 10K include photoconductors 11Y, 11M, 11C, and 11K as latent image bearers, respectively.

Each of the image forming devices 10Y, 10M, 10C, and 10K includes a charging device as a charger, an optical writing device 9 as an electrostatic-latent-image forming device, and a developing device around each of the photoconductors 11Y, 11M, 11C, and 11K. In addition, each of the image forming devices 10Y, 10M, 10C, and 10K includes a primary transfer device as a primary transferor and a cleaning device as a cleaner around each of the photoconductors 11Y, 11M, 11C, and 11K. The charging device uniformly charges the surface of the photoconductor to a predetermined potential. The optical writing device 9 irradiates the surface of the photoconductor uniformly charged by the charging device with light based on image data to form an electrostatic latent image. The developing devices develop the electrostatic latent images on the photoconductors to form toner images of toners of respective colors (yellow, magenta, cyan, and black), respectively, which is referred to as a developing process. The primary transfer device transfers the toner image on the photoconductor onto the intermediate transfer belt 20. The cleaning device removes residual toner that is not transferred onto the intermediate transfer belt and remains on the photoconductor to clean the surface of the photoconductor.

The respective color toner images formed on the photoconductors 11Y, 11M, 11C, and 11K are primarily transferred to the intermediate transfer belt 20 by the primary transfer device to overlap each other, thereby forming a color toner image on the intermediate transfer belt 20. The color toner image on the intermediate transfer belt 20 is conveyed to a region (secondary transfer region) opposite a secondary transfer device 30 as the intermediate transfer belt 20 rotates.

The image forming apparatus includes a sheet tray 60 below the image forming section 100. The sheet tray 60 holds sheets P and serves as a feeding section for feeding the sheet P. A pickup roller 61 feeds the sheets P one by one from the sheet tray 60 to a conveyance path. A registration roller pair 62 conveys the sheet P to the secondary transfer region along the conveyance path.

The registration roller pair 62 conveys the sheet P to the secondary transfer region at a specified timing at which the color toner image on the intermediate transfer belt 20 reaches the secondary transfer region, and the secondary transfer device 30 secondarily transfers the color toner image from the intermediate transfer belt 20 onto the sheet P. The sheet P on which the color toner image is formed is then conveyed to a fixing device 40 that is an example of a heating device, and the fixing device 40 applies heat and pressure to the sheet P to fix the color toner image onto the sheet P. After the color toner image is fixed onto the sheet P, the sheet P is conveyed along the conveyance path, and an output roller pair 63 ejects the sheet P to an output tray 50.

FIG. 2 is a schematic diagram illustrating a configuration of the fixing device 40 according to the present embodiment. The fixing device 40 includes a pressure roller 41 as a pressure rotator, a fixing belt 42 as a rotator, a heater 43, which is a halogen heater in FIG. 2, a stay 44 as a support, a nip formation pad 45, and a reflector 48. The heater 43, the stay 44, the nip formation pad 45 held by the stay 44, and the reflector 48 are disposed inside the loop of the fixing belt 42. A fixing nip N is formed between the pressure roller 41 and the fixing belt 42. In the fixing nip N, heat and pressure are applied to the sheet to fix the image onto the sheet.

The pressure roller 41, the fixing belt 42, the heater 43, the stay 44, the nip formation pad 45, and the reflector 48 extend in a direction perpendicular to the sheet surface of FIG. 2. The direction perpendicular to the sheet surface of FIG. 2 is the longitudinal direction of each of these components and is referred to simply as the longitudinal direction below. The longitudinal direction is parallel to a rotational axis direction of the pressure roller 41 and a rotational axis direction of the fixing belt 42. The vertical direction in FIG. 2 is parallel to a conveyance direction in which the sheet P is conveyed. The horizontal direction in FIG. 2 is parallel to a pressing direction in which the pressure roller 41 presses against the fixing belt 42.

The nip formation pad 45 includes a thermal equalizer 45a disposed on a nip face and a resin pad 45b supporting the thermal equalizer 45a. The thermal equalizer 45a transfers heat to form a uniform temperature distribution, and the fixing belt 42 slides on the thermal equalizer 45a. One of the functions of the resin pad 45b is thermal insulation to reduce heat transferred from the fixing belt 42 to the stay 44 via the nip formation pad 45. The above-described structure prevents a warm-up time and a Typical Electricity Consumption (TEC) value from increasing. The thermal equalizer 45a has, for example, a pad shape extending in the longitudinal direction of the fixing belt 42. The thermal equalizer 45a is disposed to equalize the temperature distribution of the fixing belt in the longitudinal direction of the fixing belt. The thermal equalizer 45a transfers heat from a high temperature portion of the fixing belt 42 to a low temperature portion of the fixing belt 42 to equalize the temperature distribution of the fixing belt 42 in the longitudinal direction.

In FIG. 2, the fixing nip N has a flat shape but may have a concave shape or other shapes. The fixing nip having the concave shape causes the direction in which the leading end of the sheet P is ejected from the fixing nip to be the direction toward the pressure roller, which enhances separation of the sheet P from the fixing belt 42 and prevents the occurrence of a sheet jam.

The thermal equalizer 45a is made of metal such as aluminum or copper and has a high thermal conductivity of 50 [W/m·K] or more, and the surface of the thermal equalizer 45a is coated with a coating having an excellent sliding property. Examples of the material for the coating include resin-based materials such as polyimide resin, fluororesin, polyphenylene sulfide resin, and saturated polyester resin. The above-described resin-based coating material may be mixed with glass fiber, carbon, graphite, graphite fluoride, carbon fiber, molybdenum disulfide, or fluororesin.

Alternatively, metal-based coating material may be used. Examples of the metal-based coating material include molybdenum disulfide, nickel, and composite plating of nickel and fluorine resin. In addition, the metal-based coating material may be anodized aluminum or anodized aluminum impregnated with resin or metal. Ceramics may also be used as the coating material. Examples of the ceramic used as the coating material include silicon carbide ceramic, silicon nitride ceramic, alumina ceramic, and mixtures thereof with molybdenum disulfide and fluorine resin.

Alternatively, forming an anodized aluminum layer on the surface layer of the thermal equalizer 45a made of aluminum or aluminum alloys and filling the fine pores of the anodized aluminum layer with molybdenum disulfide generated by secondary electrolysis from the deepest portions of the fine pores to the outermost surface layer forms an excellent coating. The thermal equalizer 45a having a high thermal conductivity in the present embodiment is made of a material having a thermal conductivity equal to or higher than the thermal conductivity of aluminum and is processed as described above. Thus, the thermal equalizer 45a having the high thermal conductivity is produced.

The pressure roller 41 includes a metal roller, a silicone rubber layer on the outer circumferential face of the metal roller, and a release layer on the outer circumferential face of the silicone rubber layer. The release layer is made of perfluoroalkoxy alkane (PFA) or polytetrafluoroethylene (PTFE) to obtain releasability. A spring presses the pressure roller 41 against the fixing belt 42 to deform the silicone rubber layer. As a result, the fixing nip has a predetermined nip width.

A driver such as a motor is disposed in the image forming apparatus and transmits driving force to the pressure roller 41 through gears to rotate the pressure roller 41. The pressure roller 41 transmits the driving force to the fixing belt 42 at the fixing nip to rotate the fixing belt 42.

The pressure roller 41 may be a solid roller but is preferably hollow because the hollow roller has a small thermal capacity. The pressure roller 41 may include a heater such as a halogen heater. The silicone rubber layer of the pressure roller 41 may be made of solid rubber. Alternatively, if no heater is situated inside the pressure roller 41, the silicone rubber layer of the pressure roller 41 may be made of sponge rubber. The sponge rubber is preferable to the solid rubber because the sponge rubber has enhanced thermal insulation that draws less heat from the fixing belt 42.

The fixing belt 42 is an endless belt or film and includes a base layer made of metal such as nickel or steel use stainless (SUS) or resin such as polyimide. The surface layer of the fixing belt 42 has a release layer. The release layer is made of perfluoroalkoxy alkane (PFA) or polytetrafluoroethylene (PTFE) to facilitate separation of toner of the toner image on the sheet P from the fixing belt 42, thus preventing the toner of the toner image from adhering to the fixing belt 42.

An elastic layer made of, e.g., silicone rubber may be interposed between the base layer and the release layer in the fixing belt 42. Omitting the elastic layer made of silicone rubber reduces thermal capacity and enhances a fixing performance. However, the slight surface roughness of the fixing belt 42 may be transferred onto the toner image while the toner image is pressed and fixed onto the recording medium, causing an orange-peel image, which is an image having uneven gloss in a solid part of the image. To prevent the uneven gloss or the orange peel image, the elastic layer made of silicone rubber has a thickness of 100 μm or more. Deformation of the elastic layer made of silicone rubber absorbs the slight surface roughness of the fixing belt 42, preventing the formation of the orange-peel image.

The stay 44 has a hollow pipe-shaped metal body made of metal such as aluminum, iron, or stainless steel. In the present embodiment, a cross-sectional shape of the stay 44 has square angles but may have another cross-sectional shape. The stay 44 prevents bending of the nip formation pad 45 that receives pressure from the pressure roller 41 and uniformly forms the nip width in the longitudinal direction.

Two heaters 43 are disposed inside the loop of the fixing belt 42 to heat the fixing belt 42. The heaters 43 in the present embodiment are halogen heaters and directly heat the inner circumferential surface of the fixing belt 42 with radiant heat. As long as the heater 43 can heat the fixing belt 42, the heater 43 may be one of various types of heaters such as a heater including an induction heating (IH) coil, a resistive heat generator, or a carbon heater.

The fixing device 40 includes a reflector 48 inside the loop of the fixing belt 42. The reflector 48 reflects the radiant heat from the heaters 43 to the fixing belt 42 to reduce loss of the radiant heat. The reflector 48 is made of a high-luminance aluminum, which includes a base made of a high-purity aluminum material as a metal member to obtain a high reflectance, for example, a reflectivity of 95% or more. The base has a surface layer including multiple reflection enhancing films and protective films. Depending on the configuration, silver may be deposited on an aluminum plate by vapor deposition to further increase the reflectance. The reflectance of the reflector 48 in the present embodiment is measured using a spectrophotometer that is the ultraviolet visible infrared spectrophotometer UH4150 manufactured by Hitachi High-Technologies Corporation in which the incident angle is set to 5°.

The reflector 48 includes a reflecting portion 48a, a pressure receiving portion 48b, and a connecting portion 48c. The reflecting portion 48a reflects the radiant heat toward the fixing belt. The pressure receiving portion 48b receives the pressure of the pressure roller 41 via the fixing belt 42 and the thermal equalizer 45a. The connecting portion 48c is disposed between the reflecting portion 48a and the pressure receiving portion 48b. The reflecting portion 48a is disposed between the heater 43 and the stay 44. The pressure receiving portion 48b is interposed between the thermal equalizer 45a and the resin pad 45b.

In the present embodiment, the reflecting portion 48a extends from one end of the reflector 48 to a portion facing the heaters 43. The pressure receiving portion 48b includes a plate portion interposed between the thermal equalizer 45a and the resin pad 45b and pressed by the pressure roller 41. The pressure receiving portion extends from the other end of the reflector 48 to a portion extending in parallel from the plate portion. The connecting portion 48c is between the reflecting portion 48a and the pressure receiving portion 48b. However, the connecting portion 48c may be considered as an actual boundary between the reflecting portion 48a and the pressure receiving portion 48b. In this case, most of the reflector 48 is the reflecting portion 48a and the pressure receiving portion 48b. The pressure receiving portion 48b is thermally connected to the connecting portion 48c and the reflecting portion 48a. The term “thermally connected” means that heat transfer between portions connected is possible.

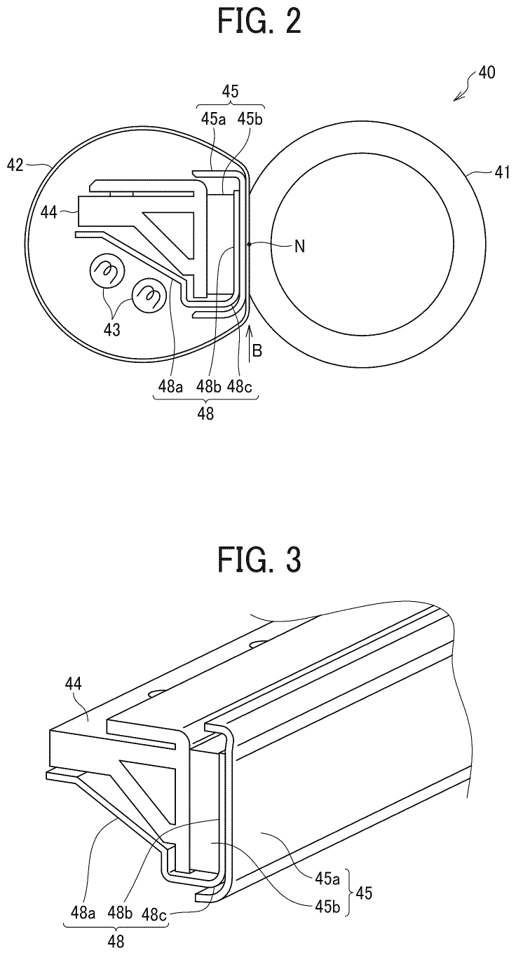

FIG. 3 is a partial perspective view of the reflector 48, the nip formation pad 45, and the stay 44 that are assembled.

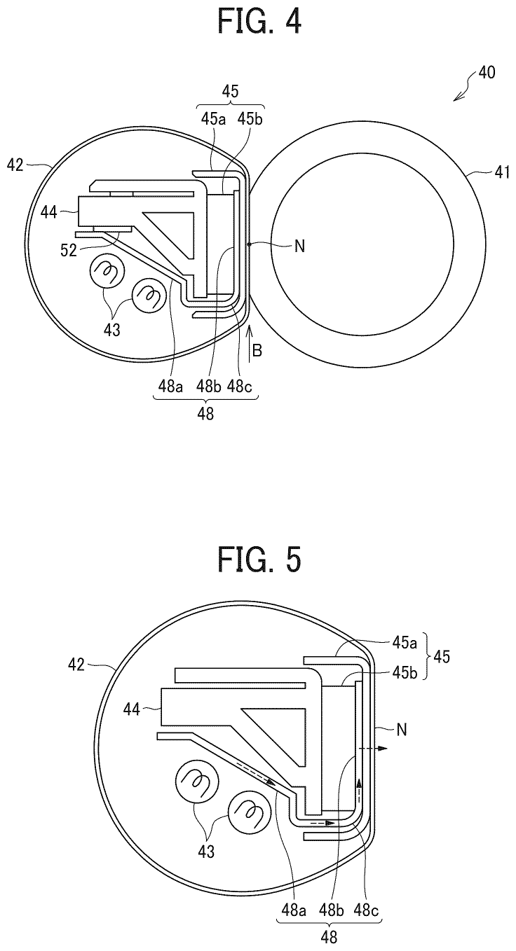

As illustrated in FIG. 3, the pressure receiving portion 48b of the reflector 48 is held by being sandwiched between the thermal equalizer 45a and the resin pad 45b, and a portion other than the pressure receiving portion 48b in the reflector 48 is not in contact with a member around the reflector 48. The pressure receiving portion 48b is located in a pressure region that receives the pressure from the pressure roller 41. Instead of the configuration illustrated in FIG. 2, the reflector 48 may be in contact with the stay 44 via a heat insulating material 52 as illustrated in FIG. 4. The configuration illustrated in FIG. 4 stabilizes the posture of the reflector 48.

The pressure receiving portion 48b is disposed in a region where the pressure receiving portion 48b receives the pressure from the pressure roller 41, and the region is between the thermal equalizer 45a and the resin pad 45b. Since the reflector 48 is made of metal having good thermal conductivity such as aluminum as described above, heat absorbed in the reflecting portion 48a quickly transmits to the entire reflector 48. The heat of the reflector 48 transfers from the pressure receiving portion 48b to the thermal equalizer 45a because the pressure receiving portion 48b is in contact with the thermal equalizer 45a, preventing temperature increase in the reflector 48. After the heat of the reflector 48 transfers to the thermal equalizer 45a, the heat transfers from the thermal equalizer 45a to the fixing belt 42 and is used for melting toner. The above-described configuration can more effectively use the heat of the reflector 48 than a configuration in which another member such as the stay 44 dissipates the heat of the reflector 48. As a result, the above-described configuration can shorten a lighting time of the heater 43 and reduce power consumption.

As illustrated in FIGS. 2 and 3, a clearance is formed between the reflector 48 and the bent portion of the thermal equalizer 45a, and a clearance is formed between the reflector 48 and the stay 44. As a result, the reflector 48 is not in contact with the bent portion of the thermal equalizer 45a and the stay 44. The above-described structure can prevent heat transfer from the reflector 48 to the bent portion of the thermal equalizer 45a and the stay 44, which are unnecessary in terms of effective use of heat.

Since the thermal equalizer 45a is coated with the above-described coating having the excellent sliding property, the friction coefficient of the thermal equalizer 45a with respect to the inner circumferential surface of the fixing belt 42 is smaller than the friction coefficient of the surface of the pressure receiving portion 48b with respect to the inner circumferential face of the fixing belt 42. Thus, the sliding resistance of the fixing belt 42 can be reduced as compared with a case in which the pressure receiving portion 48b of the reflector 48 is brought into contact with the inner circumferential surface of the fixing belt 42. The above-described structure prevents an increase in torque for rotating the fixing belt 42 and abrasion of the inner circumferential surface of the fixing belt 42.

Since the inner circumferential surface of the fixing belt 42 slides on the thermal equalizer 45a in the present embodiment, the reflector 48 does not need the excellent slidability with respect to the inner circumferential surface of the fixing belt 42. Accordingly, it is not necessary to apply the coating having the excellent sliding property to the pressure receiving portion 48b, which prevents manufacturing difficulty and an increase in cost.

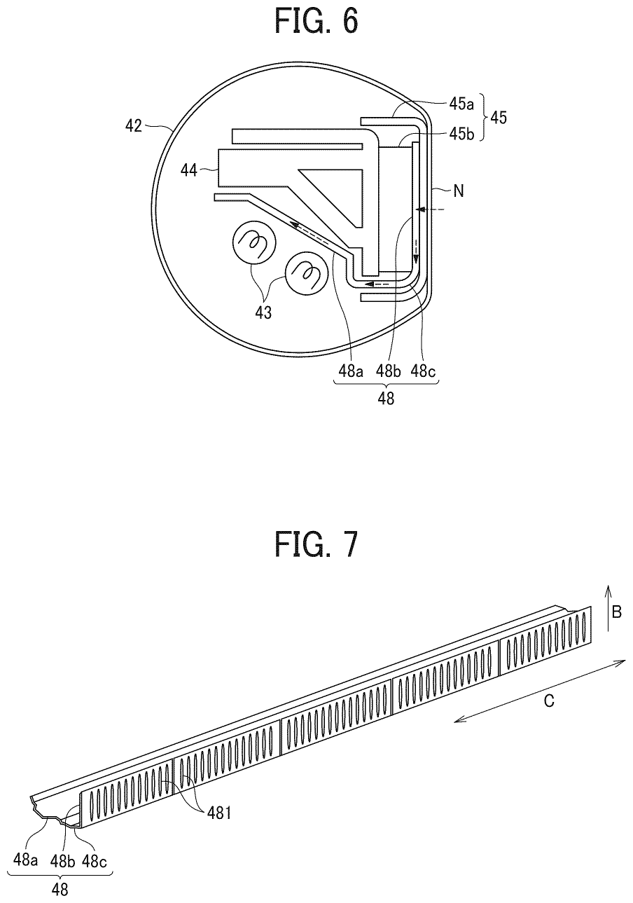

When components inside the loop of the fixing belt 42 is hot as described above, the heat of the reflector 48 can be supplied from the reflecting portion 48a to the fixing nip N via the pressure receiving portion 48b as illustrated in FIG. 5 (see the arrows in FIG. 5). However, when the components inside the loop of the fixing belt 42 is cold, for example, at the time of start-up of the image forming apparatus, heat of the fixing belt 42 flows from the thermal equalizer 45a to the reflecting portion 48a via the pressure receiving portion 48b (see arrows in FIG. 6). The heat of the fixing belt 42 is taken away by the reflector 48. As a result, issues are caused. The time required to raise the temperature of the fixing belt 42 to the fixing temperature necessary for the fixing operation becomes long, and a first print time becomes long.

FIG. 7 is a perspective view of the reflector according to the present embodiment.

As illustrated in FIG. 7, the pressure receiving portion 48b of the reflector 48 has multiple holes 481. The multiple holes 481 are arranged in the longitudinal direction of the reflector 48, and each hole 481 extends in the conveyance direction in which the sheet is conveyed. In other words, each hole 481 has a length in the conveyance direction longer than a length in the longitudinal direction. In addition, the pressure receiving portion 48b in the present embodiment includes multiple plates arranged in parallel in the longitudinal direction C.

The holes 481 in the pressure receiving portion 48b hinder and limit heat transfer in the pressure receiving portion 48b. Accordingly, when the components inside the loop of the fixing belt 42 are cold, the above-described structure can limit the heat transfer from the pressure receiving portion 48b to the reflecting portion 48a and reduce the amount of heat flowing from the fixing belt 42 to the reflector 48. In particular, arranging the holes 481 in the pressure receiving portion 48b reduces the contact area between the pressure receiving portion 48b and the thermal equalizer 45a. Reducing the contact area between the pressure receiving portion 48b and the thermal equalizer 45a reduces the amount of heat flowing from the fixing belt 42 to the pressure receiving portion 48b via the thermal equalizer 45a when the components inside the loop of the fixing belt 42 are cold.

Modifications of the reflector 48 are described below in order.

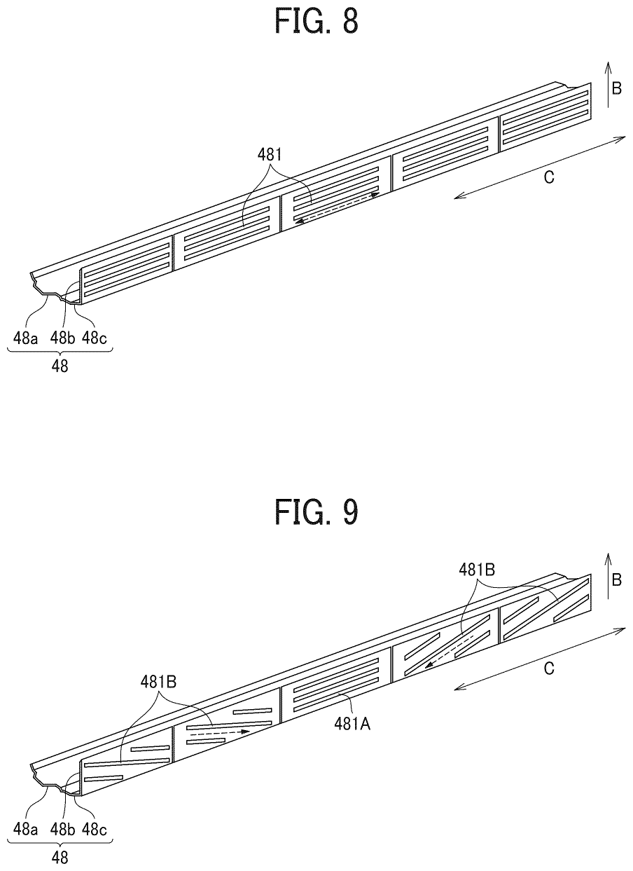

The reflector 48 illustrated in FIG. 8 has the holes 481 extending in the longitudinal direction C. In other words, a length of the hole 481 in the longitudinal direction C is longer than a length of the hole 481 in the transverse direction. The transverse direction is parallel to a direction along the surface of the pressure receiving portion 48b and orthogonal to the longitudinal direction. In addition, the transverse direction is parallel to the conveyance direction B in which the sheet is conveyed. The holes 481 are arranged in the longitudinal direction C in three rows in the conveyance direction B.

Disposing the holes 481 each having the length in the longitudinal direction longer than the length in the transverse direction can reduce the amount of heat transferred in the transverse direction to be smaller than the amount of heat transferred in the longitudinal direction C in the pressure receiving portion 48b. The above-described structure can limit the heat transfer from the pressure receiving portion 48b to the reflecting portion 48a via the connecting portion 48c and reduce the amount of heat flowing from the fixing belt 42 to the reflector 48.

The reflector 48 illustrated in FIG. 9 is described below. The reflector 48 has holes 481A extending in the longitudinal direction C. The holes 481A are in the center part of the pressure receiving portion 48b in the longitudinal direction C. In the present embodiment, the pressure receiving portion 48b has five plates arranged in the longitudinal direction, and the holes 481A are in the third of the five plates. In addition, the reflector 48 has holes 481B in plates arranged from both sides of the center plate that are the first and second and the fourth and fifth of the five plates in the embodiment in the longitudinal direction C. The hole 481B extends in a direction inclined with respect to a longitudinal direction of the pressure receiving portion and has an upstream end in a conveyance direction orthogonal to the longitudinal direction and a downstream end downstream from the upstream end in the conveyance direction, and the upstream end is closer to the center of the pressure receiving portion than the downstream end in the longitudinal direction.

The holes 481B inclined as described above can limit the heat transfer from the pressure receiving portion 48b to the reflecting portion 48a via the connecting portion 48c like the holes 481 in FIG. 8. In addition, the hole 481B inclined as described above can easily collect the heat amount to the center of the pressure receiving portion 48b in the longitudinal direction C. As a result, the above-described configuration can prevent heat from flowing out from the ends of the pressure receiving portion 48b in the longitudinal direction C. Accordingly, the above-described configuration can prevent heat from flowing out from the fixing belt to the reflector 48.

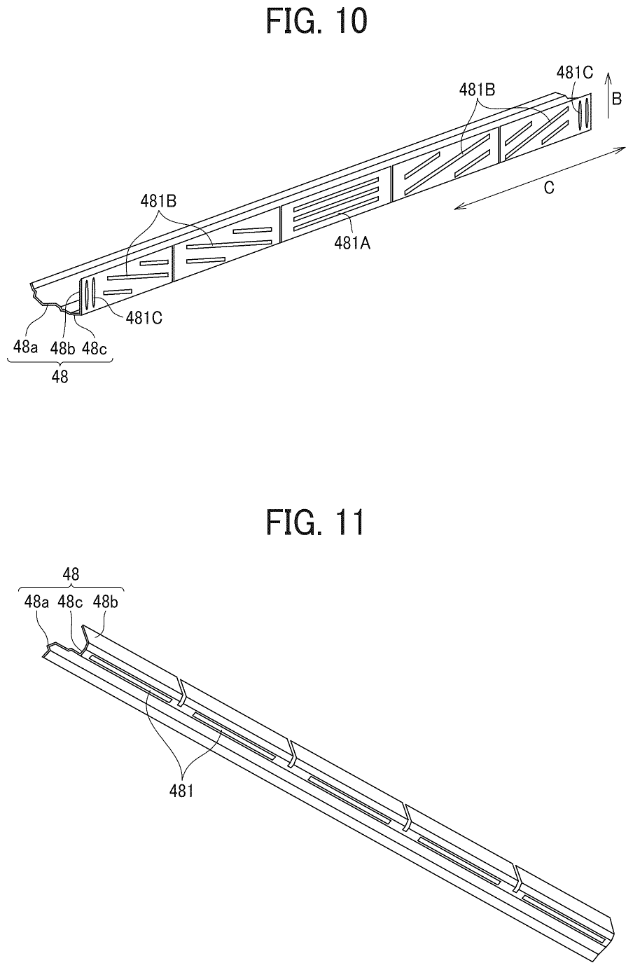

The reflector 48 illustrated in FIG. 10 is described below. The reflector 48 in FIG. 10 has holes 481C extending in the conveyance direction B in addition to the holes 481A and 481B arranged as illustrated in FIG. 9. In other words, the length of the hole 481C in the conveyance direction is longer than the length of the hole 481C in the longitudinal direction orthogonal to the conveyance direction. The holes 481C are in plates disposed at both ends of the pressure receiving portion 48b in the longitudinal direction. In other words, the hole 481C is disposed at an end of the pressure receiving portion in the longitudinal direction. The above-described configuration can limit heat transfer in the longitudinal direction C from both ends of the pressure receiving portion and prevent heat from flowing out from the ends of the pressure receiving portion 48b in the longitudinal direction C. In the present embodiment, the hole 481C extending in the conveyance direction is at a position close to an edge of the pressure receiving portion and close to the hole 481B that is closest to the end of the pressure receiving portion 48b among the holes 481 but may be at an end portion of the pressure receiving portion 48b in the longitudinal direction. The end portion of the pressure receiving portion 48b in the longitudinal direction may be, for example, one of both end portions of the pressure receiving portion 48b divided into three equal parts in the longitudinal direction C. The hole 481C may be added to the arrangement of the holes 481 in FIG. 8, and the combination of the hole configurations can be selected as appropriate.

The reflector 48 illustrated in FIG. 11 has the holes 481 in the connecting portion 48b, not in the pressure receiving portion 48c. The above-described configuration can limit the heat transfer from the pressure receiving portion 48b to the reflecting portion 48a via the connecting portion 48c, and heat is less likely to flow from the pressure receiving portion 48b to the reflecting portion 48a. Accordingly, the above-described configuration can prevent heat from flowing out from the fixing belt 42 to the reflector 48, in particular, to the reflecting portion 48a. In the following description, a configuration that prevents heat from flowing out from a rotator such as the fixing belt 42 to the reflecting portion 48a and prevents the heat transfer to the reflecting portion in the reflector is referred to as a heat transfer preventer. The above-described hole 481 is an example of the heat transfer preventer. The heat transfer preventer such as the hole 481 may be disposed in both the pressure receiving portion 48b and the connecting portion 48c.

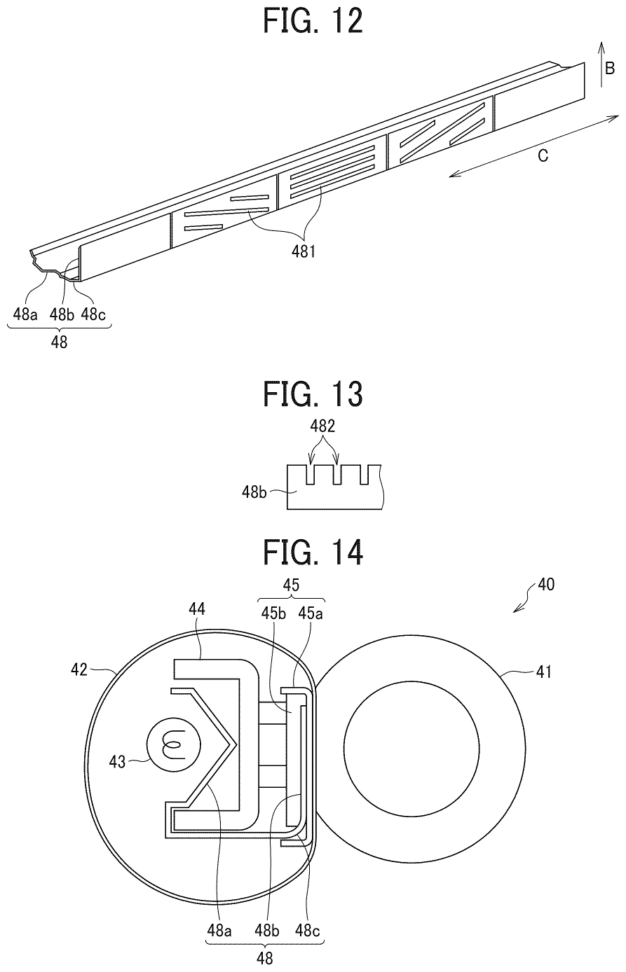

The heat transfer preventer does not need to be disposed over the entire region of the pressure receiving portion and the connecting portion in the longitudinal direction C. For example, as illustrated in FIG. 12, the holes may be at the center part of the pressure receiving portion 48b and not be at both ends of the pressure receiving portion 48b. In the embodiment of FIG. 12, the pressure receiving portion 48b has the five plates, and the holes 481 are in the second to fourth plates of the five plates. The first and fifth plates at both ends do not have the holes 481. In the above-described configuration, heat is easily discharged from the fixing belt 42 to both ends of the reflector 48 in the longitudinal direction. As a result, the above-described configuration can reduce the temperature rise at the end of the fixing belt 42 that occurs when small sheets continuously pass through the fixing device. In this way, the arrangement and size of the holes (or grooves or low thermal conductors described below) may be changed as appropriate mainly according to the amount of heat required for the fixing belt 42.

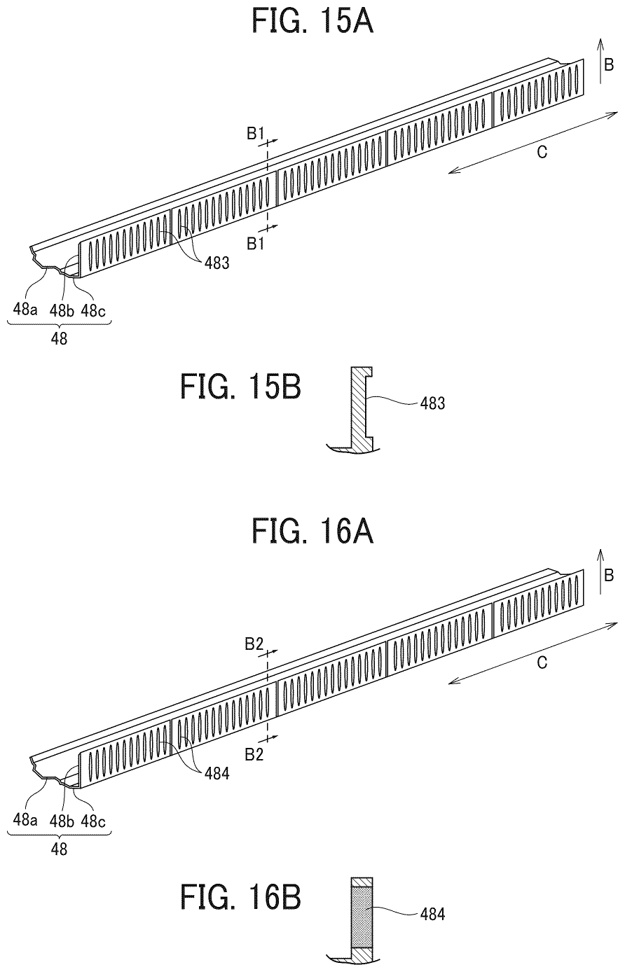

Instead of the hole 481, the reflector 48 may have a groove 483 that does not penetrate the reflector 48 in the thickness direction as illustrated in FIGS. 15A and 15B. Similarly to the hole 481, the groove limits heat transfer in the pressure receiving portion 48b or the connecting portion 48c and hampers the heat transfer from the pressure receiving portion 48b or the connecting portion 48c to the reflecting portion 48a. As a result, the above-described configuration can prevent heat from flowing out from the fixing belt to the reflector 48.

In particular, the groove in the pressure receiving portion 48b has a concave shape (concave to the left side in FIG. 2) away from the fixing nip N between the fixing belt 42 and the pressure roller 41 (see FIG. 2). In other words, the pressure receiving portion 48b may have the groove having a concave shape recessed away from the fixing nip between the fixing belt 42 and the pressure roller 41. The above-described configuration reduces the contact area between the pressure receiving portion 48b and the thermal equalizer 45a and reduces the amount of heat flowing from the fixing belt 42 to the pressure receiving portion 48b via the thermal equalizer 45a when the components inside the loop of the fixing belt 42 are cold.

Making the hole is easier than making the groove, and the hole can more significantly prevent heat from flowing out from the fixing belt to the reflector. In contrast, the reflector 48 having the grooves has a larger strength than the reflector 48 having the holes.

As illustrated in FIG. 13, the pressure receiving portion 48b may have notches 482 in a part of the pressure receiving portion 48b arranged in the longitudinal direction, the notch 482 reduces the width of the part of the pressure receiving portion 48b in the transverse direction. The above-described configuration reduces the contact area between the pressure receiving portion 48b and the thermal equalizer 45a and reduces the amount of heat flowing from the fixing belt to the reflector 48. The notches 482 may be in the connecting portion 48c.

As illustrated in FIGS. 16A and 16B, the pressure receiving portion 48b or the connecting portion 48c in the reflector 48 may include a low thermal conductor made of a material having a lower thermal conductivity than the other part of the reflector 48. The reflector 48 illustrated in FIG. 16A includes the low thermal conductor formed by injecting the material having the lower thermal conductivity into the hole 481 of the reflector illustrated in FIG. 7. In other words, at least one of the pressure receiving portion 48b and the connecting portion 48c may have a first portion 484 including the low thermal conductor having a first thermal conductivity. In this case, the reflector 48 has a second portion other than the first portion, and the second portion has a second thermal conductivity higher than the first thermal conductivity.

Changing the material of a part of the pressure receiving portion 48b or the connecting portion 48c can obtain another effect such as increasing the strength of the part of the pressure receiving portion 48b or the connecting portion 48c in addition to limiting the heat transfer. The low thermal conductor may be made of, for example, resin such as polystyrene or silicone. The above-described configuration can increase both the strength and the thermal resistance of the reflector. In the above, the other part of the reflector 48 does not necessarily mean an entire part of the reflector 48 other than the low thermal conductor. The other part of the reflector 48 may be a part of the reflector 48.

As described above, the pressure receiving portion 48b or the connecting portion 48c in the reflector 48 may include the heat transfer preventer such as the hole, the groove, or the low thermal conductor. The heat transfer preventer limits the heat transfer from the rotator to the reflector or the heat transfer to the reflecting portion in the reflector.

The reflector 48 may have a combination of the arrangements and configurations of the heat transfer preventers of FIGS. 7 to 13.

The above-described embodiments are illustrative and do not limit this disclosure. It is therefore to be understood that within the scope of the appended claims, numerous additional modifications and variations are possible to this disclosure otherwise than as specifically described herein.

FIG. 14 is a schematic diagram illustrating another configuration of a fixing device.

The fixing device 40 illustrated in FIG. 14 includes the stay 44 having a concave shape in a cross-section viewed in a direction of an imaginary rotation axis formed by rotation of the fixing belt 42 that is referred to as a rotation axis direction. The fixing device 40 includes the heater 43 disposed in the concave portion of the stay 44. Similar to the above embodiment, the reflecting portion 48a of the reflector 48 is disposed between the stay 44 and the heater 43. The reflector 48 includes the pressure receiving portion 48b that extends from a lower end of the reflecting portion 48a in FIG. 14 and is sandwiched between the resin pad 45b and the thermal equalizer 45a.

In the fixing device illustrated in FIG. 14, the heat of the reflector 48 can be dissipated to the fixing belt 42 via the thermal equalizer 45a to melt the toner. The configuration illustrated in FIG. 14 has a clearance between the reflector 48 and the bent portion of the thermal equalizer 45a and a clearance between the reflector 48 and the stay 44 so that the reflector 48 does not contact other component to prevent heat from transferring from the reflector 48 to the bent portion of the thermal equalizer 45a and the stay 44.

In the above description, the thermal equalizer 45a is disposed between the pressure receiving portion 48b of the reflector 48 and the fixing belt 42. However, a member disposed between the pressure receiving portion 48b and the fixing belt 42 may be a member having a better sliding property with respect to the inner circumferential surface of the fixing belt 42 than the reflector. For example, although a property to dissipate the heat to the fixing belt 42 is inferior to a property of the thermal equalizer 45a, a sliding sheet as the sliding member may be disposed between the pressure receiving portion 48b and the fixing belt 42. The sliding sheet is made of fibers such as PTFE impregnated with a lubricant such as silicone oil. The sliding sheet is, for example, disposed so as to be wound around the resin pad 45b and fixed by a screw on a back side of the resin pad 45b, the back side facing the stay 44.

The pressure receiving portion 48b or the connecting portion 48c in the fixing device according to the present embodiment may include the above-described heat transfer preventer. The heat transfer preventer can limit the heat from flowing out from the fixing belt 42 to the reflector 48.

The fixing device is one example of the heating device. The present embodiments are not limited to applying the fixing device and may be applied to the heating device other than the fixing device. The present embodiments can be applied to, for example, a heating device such as a dryer to dry liquid such as ink applied to the sheet, a laminator that heats, under pressure, a film serving as a covering member onto the surface of the sheet such as paper, and a thermocompression device such as a heat sealer that seals a seal portion of a packaging material with heat and pressure. Applying the present embodiments can limit the heat from flowing out from the rotator to the reflector.

The image forming apparatus according to the present embodiments of the present disclosure is applicable not only to the color image forming apparatus illustrated in FIG. 1 but also to a monochrome image forming apparatus, a copier, a printer, a facsimile machine, or a multifunction peripheral including at least two functions of the copier, printer, and facsimile machine.

The sheet is one example of a recording medium. The recording medium may be a sheet of plain paper, thick paper, thin paper, a postcard, an envelope, coated paper, art paper, tracing paper, an overhead projector (OHP) sheet, plastic film, prepreg, or copper foil.

Aspects of the present disclosure are, for example, as follows.

### First Aspect

In a first aspect, a reflector disposed in a heating device including a rotator, a pressure rotator, and a heater includes a reflecting portion, a pressure receiving portion, and a connecting portion. The reflecting portion reflects heat of the heater. The pressure receiving portion is thermally connected to the reflecting portion and receives pressure from the pressure rotator via the rotator. The connecting portion connects the reflecting portion and the pressure receiving portion. At least one of the pressure receiving portion or the connecting portion has a hole.

### Second Aspect

In a second aspect, the hole in the reflector according to the first aspect is in the pressure receiving portion, and the hole extends in a longitudinal direction of the pressure receiving portion.

### Third Aspect

In a third aspect, the hole in the reflector according to the first aspect or the second aspect is in the pressure receiving portion and extends in a direction inclined with respect to a longitudinal direction of the pressure receiving portion. The hole has an upstream end in a conveyance direction orthogonal to the longitudinal direction and a downstream end downstream from the upstream end in the conveyance direction, and the upstream end is closer to a center of the pressure receiving portion than the downstream end in the longitudinal direction.

### Fourth Aspect

In a fourth aspect, the reflector according to any one of the first to third aspects has the hole extending in a recording medium conveyance direction at an end of the pressure receiving portion in a longitudinal direction of the pressure receiving portion.

### Fifth Aspect

In a fifth aspect, a reflector disposed in a heating device including a rotator, a pressure rotator, and a heater includes a reflecting portion, a pressure receiving portion, and a connecting portion. The reflecting portion that reflects heat of the heater. The pressure receiving portion is thermally connected to the reflecting portion and receives pressure from the pressure rotator via the rotator. The connecting portion connects the reflecting portion and the pressure receiving portion. At least one of the pressure receiving portion or the connecting portion has a groove.

### Sixth Aspect

In a sixth aspect, the groove in the reflector according to the fifth aspect is in the pressure receiving portion and has a concave shape away from a nip formed between the rotator and the pressure rotator.

### Seventh Aspect

In a seventh aspect, a reflector disposed in a heating device including a rotator, a pressure rotator, and a heater includes a reflecting portion, a pressure receiving portion, and a connecting portion. The reflecting portion that reflects heat of the heater. The pressure receiving portion is thermally connected to the reflecting portion and receives pressure from the pressure rotator via the rotator. The connecting portion connects the reflecting portion and the pressure receiving portion. At least one of the pressure receiving portion or the connecting portion includes a low thermal conductor having a thermal conductivity lower than a thermal conductivity of another part of the reflector other than the low thermal conductor.

### Eighth Aspect

In an eighth aspect, a heating device includes the reflector according to any one of the first to seventh aspects, the rotator, and the pressure rotator.

### Ninth Aspect

In a ninth aspect, a fixing device includes the heating device according to the eighth aspect to fix an image on a recording medium by heat.

### Tenth Aspect

In a tenth aspect, an image forming apparatus includes the fixing device according to the ninth aspect.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A reflector comprising:
a reflecting portion in a rotator of a heating device, the reflecting portion to reflect heat from a heater in the rotator;
a pressure receiving portion, in the rotator, to receive pressure via the rotator from a pressure rotator, of the heating device, outside the rotator, the pressure receiving portion thermally connected to the reflecting portion; and
a connecting portion connecting the reflecting portion and the pressure receiving portion,
wherein at least one of the pressure receiving portion or the connecting portion has a hole.

2. The reflector according to claim 1,
wherein the pressure receiving portion has the hole inside the pressure receiving portion, and the hole extends in a longitudinal direction of the pressure receiving portion.

3. The reflector according to claim 1,
wherein the pressure receiving portion has the hole inside the pressure receiving portion,
the hole extends in a direction inclined with respect to a longitudinal direction of the pressure receiving portion,
the hole has:
an upstream end in a conveyance direction orthogonal to the longitudinal direction; and
a downstream end downstream from the upstream end in the conveyance direction, and
the upstream end is closer to a center of the pressure receiving portion than the downstream end in the longitudinal direction.

4. The reflector according to claim 1,
wherein the pressure receiving portion has the hole extending in a conveyance direction orthogonal to a longitudinal direction of the pressure receiving portion, and
the hole is disposed at an end of the pressure receiving portion in the longitudinal direction.

5. A heating device comprising:
the rotator;
the pressure rotator; and
the reflector according to claim 1.

6. A fixing device comprising the heating device according to claim 5.

7. An image forming apparatus comprising the fixing device according to claim 6.

8. A reflector comprising:
a reflecting portion in a rotator of a heating device, the reflecting portion to reflect heat from a heater in the rotator;
a pressure receiving portion, in the rotator, to receive pressure via the rotator from a pressure rotator, of the heating device, outside the rotator, the pressure receiving portion thermally connected to the reflecting portion; and
a connecting portion connecting the reflecting portion and the pressure receiving portion,
wherein at least one of the pressure receiving portion or the connecting portion has a groove.

9. The reflector according to claim 8,
wherein the pressure receiving portion has the groove having a concave recessed away from a nip between the rotator and the pressure rotator.

10. A heating device comprising:
the rotator;
the pressure rotator; and
the reflector according to claim 8.

11. A fixing device comprising the heating device according to claim 10.

12. An image forming apparatus comprising the fixing device according to claim 11.

13. A reflector comprising:
a reflecting portion in a rotator of a heating device, the reflecting portion to reflect heat from a heater in the rotator;
a pressure receiving portion, in the rotator, to receive pressure via the rotator from a pressure rotator, of the heating device, outside the rotator, the pressure receiving portion thermally connected to the reflecting portion; and
a connecting portion connecting the reflecting portion and the pressure receiving portion,
wherein at least one of the pressure receiving portion or the connecting portion includes a first portion having a first thermal conductivity,
the reflector has a second portion, other than the first portion, and
the second portion has a second thermal conductivity higher than the first thermal conductivity.

14. A heating device comprising:
the rotator;
the pressure rotator; and
the reflector according to claim 13.

15. A fixing device comprising the heating device according to claim 14.

16. An image forming apparatus comprising the fixing device according to claim 15.
